(19) United States
(12) Patent Application Publication
(10) Pub. No.: US 2006/0265426 A1
(43) Pub. Date: Nov. 23, 2006

(54) Large-size electronic file storage and retrieval handling method and system

(75) Inventor: Wen-Ruei Chen, Hsin Chu (TW)

Correspondence Address: EDWARDS & ANGELL, LLP, P.O. BOX 55874, BOSTON, MA, 02205, US

(73) Assignee: RDC Semiconductor Co., Ltd., Hsin Chu (TW)

(21) Appl. No.: 11/233,717

(22) Filed: Sep. 23, 2005

(30) Foreign Application Priority Data
May 18, 2005 (TW) 094116044

(51) Int. Cl. G06F 17/30

(52) U.S. Cl. 707/200

(57) ABSTRACT

A large-size electronic file storage and retrieval handling method and system is proposed, which is designed for use with a file management system on a computer platform that has an upper file size limit, with the purpose of providing the file management system with a large-size electronic file storage and retrieval handling function, which is characterized by the capability of dissecting a large-size file whose size exceeds the upper file size limit into a number of small-size files each with a size less than the upper file size limit, so as to allow each single large-size file to be stored into and retrieved from the computer platform in batch. This feature can be utilized on any types of computer platforms to allow the storage and retrieval of electronic files of any unlimited large sizes.

### BACKGROUND OF THE INVENTION

1. Field of the Invention

This invention relates to information technology (IT), and more particularly, to a large-size electronic file storage and retrieval handling method and system which is designed for use in conjunction with a file management system of a computer platform that has an inherent upper file size limit, such as the FAT (File Allocation Table) file management system of Microsoft Windows operating system, for providing a large-size file storage and retrieval capability that allows the file management system to handle the storage and retrieval of electronic files without any limitation in size.

2. Description of Related Art

FAT (File Allocation Table) is a file management system utilized in Microsoft Windows operating systems, which is integrated as an essential part of the operating system for installation on computer platforms, such as desktop computers, notebook computers, and network servers, and the like, for the user to handle the storage and retrieval of electronic files stored in his/her computer platform.

One drawback to the FAT file management system, however, is that it has an inherent upper file size limit, typically 4 GB (gigabyte), which allows the computer platform to handle electronic files only below 4 GB, i.e., it won't be able to store any electronic file that has a size greater than 4 GB.

Traditionally, the upper file size limit of 4 GB is more than sufficient for a PC to handle most types of electronic document files. However, with the advent and popularization of digital video technology in PC, a digitized video file could easily exceed the 4 GB limit. Since FAT file management system has an inherent upper file size limit of 4 GB, it won't allow PC users to store digitized video files having a size greater than 4 GB in the PC.

### SUMMARY OF THE INVENTION

It is therefore an objective of this invention to provide a large-size electronic file storage and retrieval handling method and system which allows PC users to store a digitized video file having a size greater than 4 GB into a FAT file management system on PC.

It is another objective of this invention to provide a large-size electronic file storage and retrieval handling method and system which allows any types of computer platforms to handle the storage and retrieval of large-size files with no limitation in file size.

The large-size electronic file storage and retrieval handling method and system according to the invention is designed for use in conjunction with a file management system of a computer platform that has an inherent upper file size limit, such as the FAT (File Allocation Table) file management system of Microsoft Windows operating system, for providing a large-size file storage and retrieval capability that allows the file management system to handle the storage and retrieval of electronic files without any limitation in size.

The large-size electronic file storage and retrieval handling method according to the invention comprises: (1) in the event of an electronic file received by the computer platform, inspecting the electronic file to check whether the size of the electronic file exceeds the inherent upper file size limit of the file management system; if YES, issuing a file dissecting enable message; (2) responding to the file dissecting enable message by dissecting the electronic file into a number of small-size files, each of which is smaller in size than the inherent upper file size limit of the file management system, and all of which are linked according to their sequential order in data continuity into an interrelated chain; and (3) building a directory in the file management system in relation to the electronic file and then storing all the dissected small-size files into that directory.

In terms of architecture, the large-size electronic file storage and retrieval handling system according to the invention comprises: (a) a file-size inspecting module, which is capable of inspecting an electronic file to check whether the size of the electronic file exceeds the inherent upper file size limit of the file management system; and if YES, capable of issuing a file dissecting enable message; (b) a file dissecting module, which is capable of responding to the file dissecting enable message from the file-size inspecting module by dissecting the electronic file into a number of small-size files, each of which is smaller in size than the inherent upper file size limit of the file management system, and all of which are linked according to their sequential order in data continuity into an interrelated chain; and (c) a file storing module, which is capable of firstly building a directory in the file management system in relation to the electronic file and then storing all the dissected small-size files generated by the file dissecting module into that directory.

The large-size electronic file storage and retrieval handling method and system according to the invention is characterized by the capability of dissecting each exceedingly-large electronic file into a number of small-size files each having a size smaller than the inherent upper file size limit of the file management system, such that these small-size files can be stored altogether in a directory in the file management system whose name is related to the filename of the electronic file to be stored. This feature can be utilized on any types of computer platforms to allow the storage and retrieval of any large-size files with no limitation in file size.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application and system architecture of the large-size electronic file storage and retrieval handling system of the invention;

FIG. 2 is a schematic diagram showing the sequentially-chained relationship of a number of small-size files dissected from a large-size file; and

FIG. 3 is a schematic diagram showing the structure of a directory in a file management system where a group of small-size files related to a large-size file are stored.

### DETAILED DESCRIPTION OF PREFERRED EMBODIMENTS

The large-size electronic file storage and retrieval handling method and system according to the invention is disclosed in full details by way of preferred embodiments in the following with reference to the accompanying drawings.

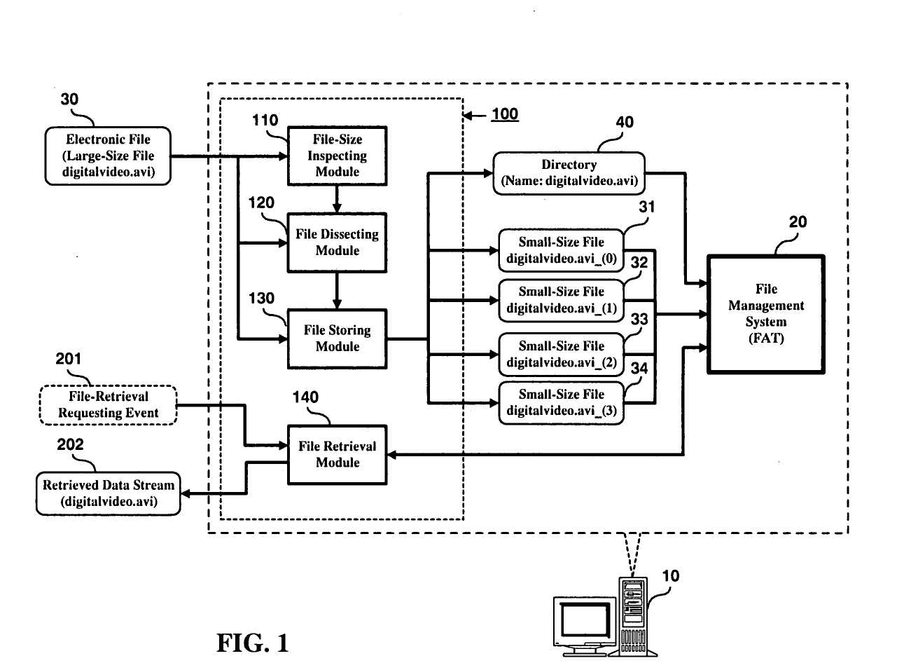

FIG. 1 is a schematic diagram showing the application and system architecture of the large-size electronic file storage and retrieval handling system according to the invention (as the part enclosed in the dotted box indicated by the reference numeral 100). As shown, the large-size electronic file storage and retrieval handling system of the invention 100 is designed for use in conjunction with a computer platform 10, such as a desktop computer, a notebook computer, or a network server, that is equipped with a file management system 20 having an inherent upper file size limit, such as the FAT (File Allocation Table) file management system of Microsoft Windows operating system that has an inherent upper file size limit of only 4 GB (gigabyte), for providing a large-size file storage and retrieval capability that allows the file management system 20 to handle the storage and retrieval of an electronic file 30 whose size is greater than the inherent upper file size limit of FAT. It is to be noted that herein and throughout this specification, including claims, the term “large-size file” refers to an electronic file whose size is greater than the inherent upper file size limit of the file management system 20, and the term “small-size file” refers to an electronic file whose size is smaller than the inherent upper file size limit of the file management system 20.

In the following description of an example of a practical application of the invention, it is assumed that the electronic file 30 is a digitized video file whose filename is “digitalvideo.avi”, and which is a large-size file whose size is 12 GB which is much greater than the inherent upper file size limit of 4 GB of the file management system 20.

As shown in FIG. 1, the modularized object-oriented component model of the large-size electronic file storage and retrieval handling system of the invention 100 comprises: (a) a file-size inspecting module 110; (b) a file dissecting module 120; and (c) a file storing module 130; and can further comprise a file retrieval module 140. In practical implementation, for example, the large-size electronic file storage and retrieval handling system of the invention 100 can be fully realized by computer code which is integrated as an add-on software or firmware module to the operating system of the computer platform 10 to be executed to provide the desired large-size file storage and retrieval function.

The file-size inspecting module 110 is capable of being activate in the event that the user wants to store an electronic file 30 into the file management system 20 of the computer platform 10 to inspect the electronic file 30 by checking whether the size of the electronic file 30 exceeds the inherent upper file size limit of the file management system 20. If YES, the file-size inspecting module 110 will issue a file dissecting enable message.

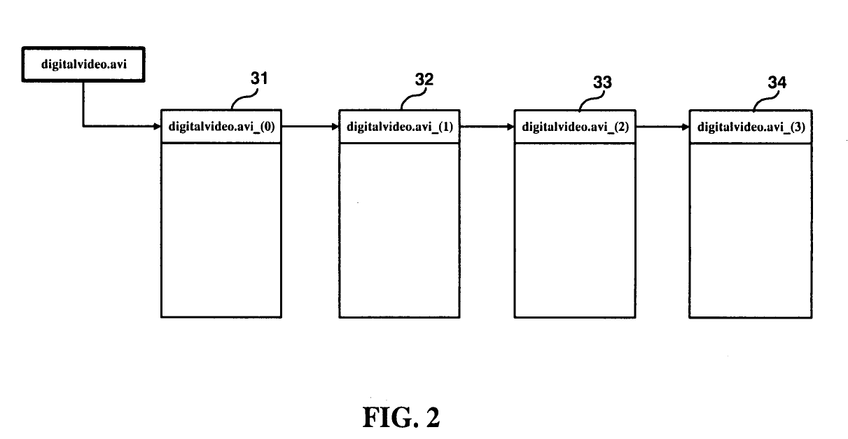

The file dissecting module 120 is capable of responding to the file dissecting enable message from the file-size inspecting module 110 by dissecting the electronic file 30 into a number of small-size files (in the example of FIG. 1, the electronic file 30 is dissected into 4 small-size files 31, 32, 33, 34), each of which is smaller in size than the inherent upper file size limit of the file management system 20, and all of which are sequentially linked according to the order of data continuity as illustrated in FIG. 2. In practical implementation, for example, the dissecting algorithm performed by this file dissecting module 120 can be realized in such a manner that in the first step, the large-size electronic file 30 is dissected into two equal portions to see if each halved portion is smaller in size than the inherent upper file size limit of the file management system 20; and if NO, the same dissecting step is repeated again to dissect each halved portion into two equal portions; and so forth until each dissected portion is smaller in size than the inherent upper file size limit of the file management system 20. For example, if the original electronic file 30 has a size of 12 GB, then the file dissecting module 120 will first dissect the 12 GB electronic file 30 into two 6 GB files, and then dissect each 6 GB file into two 3 GB files (i.e., the electronic file 30 is dissected into four 3 GB files). It is to be noted, however, various other dissecting algorithms can be utilized for the dissecting of the electronic file 30 into a number of small-size files. Further, the four dissected small-size files 31, 32, 33, 34 can be named by appending an index number to the file extension of the original electronic file 30. For example, if the filename of the original electronic file 30 is “digitalvideo.avi”, then the four dissected small-size files 31, 32, 33, 34 can be named respectively as “digitalvideo.avi_(0)”, “digitalvideo.avi_(1)”, “digitalvideo.avi_(2)”, and “digitalvideo.avi_(3)”.

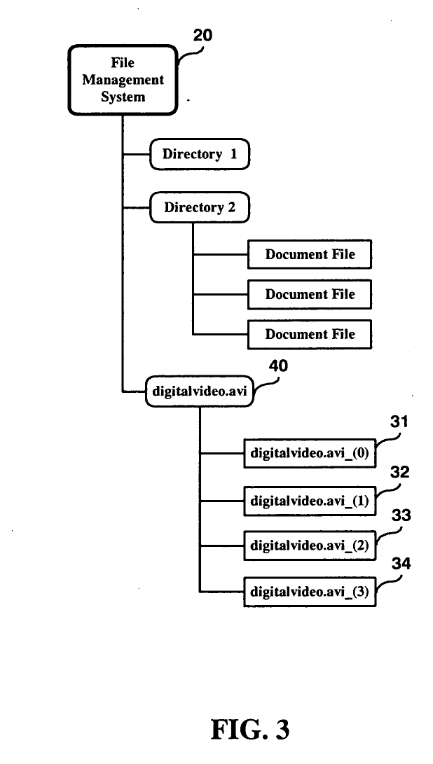

The file storing module 130 is capable of firstly building a directory 40 in the file management system 20 in relation to the electronic file 30 and then storing all the small-size files 31, 32, 33, 34 generated by the file dissecting module 120 into this directory 40. In the example of FIG. 1, since the filename of the electronic file 30 is “digitalvideo.avi”, the directory 40 is correspondingly named as “digitalvideo.avi” as illustrated in FIG. 3 for the storage of the four dissected small-size files 31, 32, 33, 34 into the “digitalvideo.avi” directory 40.

The file retrieval module 140 is capable of responding to a file-retrieval requesting event 201 directed at the electronic file 30 by firstly searching through the file management system 20 for a directory 40 whose name is related to the filename of the electronic file 30; and if found, capable of retrieving all the small-size files 31, 32, 33, 34 stored in that directory 40 and then combine the contents of these small-size files 31, 32, 33, 34 according to their sequentially-chained relationship shown in FIG. 2 into a single data stream 202 whose content is the same as the original large-size electronic file 30.

The following is a detailed description of an example of a practical application of the large-size electronic file storage and retrieval handling system of the invention 100. In this application example, it is assumed that the electronic file 30 is a digitized video file having an exceedingly large size of 12 GB (which is much greater than the inherent upper file size limit of 4 GB of the file management system 20), and whose filename if “digitalvideo.avi”.

Referring to FIG. 1 through FIG. 3 together, in actual operation, whenever the computer platform 10 receives an electronic file 30 and the user wants to save the electronic file 30 into the file management system 20, it will activate the file-size inspecting module 110 to inspect the electronic file 30 by checking whether the size of the electronic file 30 exceeds the inherent upper file size limit of the file management system 20. Since the electronic file 30 has a size of 12 GB which exceeds the inherent upper file size limit of 4 GB of the file management system 20, it will cause the file-size inspecting module 110 to issue a file dissecting enable message to the file dissecting module 120. In response, the file dissecting module 120 is activated to perform a file dissecting procedure to dissect the 12 GB electronic file 30 into four small-size files 31, 32, 33, 34, each having a size of 3 GB which is smaller than the inherent upper file size limit of 4 GB of the file management system 20. Moreover, since the filename of the 12 GB electronic file 30 is “digitalvideo.avi”, the four small-size files 31, 32, 33, 34 are respectively named as “digitalvideo.avi_(0)”, “digitalvideo.avi_(1)”, “digitalvideo.avi_(2)”, and “digitalvideo.avi_(3)”. These small-size files 31, 32, 33, 34 are further linked according to their sequential order in data continuity into an interrelated chain as illustrated in FIG. 2. Subsequently, the file storing module 130 is activated to firstly build a directory 40 whose name is related to the filename of the electronic file 30, for example in exactly the same name as the electronic file 30 (i.e., “digitalvideo.avi”), and then store the four dissected small-size files 31, 32, 33, 34 into this directory 40. This completes the storage of the exceedingly-large 12 GB electronic file 30 into the file management system 20.

Afterwards, when the user wants to retrieve the 12 GB electronic file 30 from the file management system 20, the user can initiate a file-retrieval requesting event 201 on the computer platform 10, causing the file retrieval module 140 to respond by firstly searching through the file management system 20 for a directory 40 whose name is related to the filename of the requested electronic file 30 (in this example, the directory name is “digitalvideo.avi”. When found, the file retrieval module 140 will retrieve all the small-size files 31, 32, 33, 34 stored in that directory 40 and then combine the contents of these small-size files 31, 32, 33, 34 according to their sequentially-chained relationship shown in FIG. 2 into a single data stream 202 whose content is the same as the original 12 GB electronic file 30.

In conclusion, the invention provides a large-size electronic file storage and retrieval handling method and system for use with a file management system of a computer platform for providing the file management system with a large-size file storage and retrieval function, and which is characterized by the capability of dissecting each exceedingly-large electronic file into a number of small-size files each having a size smaller than the inherent upper file size limit of the file management system, such that these small-size files can be stored altogether in a directory in the file management system whose name is related to the filename of the electronic file to be stored. This feature can be utilized on any types of computer platforms to allow the storage and retrieval of any large-size files with no limitation in file size. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A large-size electronic file storage and retrieval handling method for use on a file management system of a computer platform that has an inherent upper file size limit for providing the file management system with a large-size file storage and retrieval capability;
the large-size electronic file storage and retrieval handling method comprising:
in the event of an electronic file received by the computer platform, inspecting the electronic file to check whether the size of the electronic file exceeds the inherent upper file size limit of the file management system; if YES, issuing a file dissecting enable message;
responding to the file dissecting enable message by dissecting the electronic file into a number of small-size files, each of which is smaller in size than the inherent upper file size limit of the file management system, and all of which are linked according to their sequential order in data continuity into an interrelated chain; and
building a directory in the file management system in relation to the electronic file and then storing all the dissected small-size files into that directory.

2. The large-size electronic file storage and retrieval handling method of claim 1, wherein the computer platform is a desktop computer.

3. The large-size electronic file storage and retrieval handling method of claim 1, wherein the computer platform is a notebook computer.

4. The large-size electronic file storage and retrieval handling method of claim 1, wherein the computer platform is a network server.

5. The large-size electronic file storage and retrieval handling method of claim 1, wherein the file management system is a FAT (File Allocation Table) file management system of Microsoft Windows operating system.

6. The large-size electronic file storage and retrieval handling method of claim 1, further comprising:
responding to a file-retrieval requesting event by searching through the file management system for a directory whose name is related to the name of the electronic file being requested; and
from the found directory, retrieving all the small-size files stored in the found directory and combine the contents of these small-size files into a single data stream based on the sequential order of these small-size files.

7. A large-size electronic file storage and retrieval handling system for use with a file management system of a computer platform that has an inherent upper file size limit for providing the file management system with a large-size file storage and retrieval capability;
the large-size electronic file storage and retrieval handling system comprising:
a file-size inspecting module, which is capable of inspecting an electronic file to check whether the size of the electronic file exceeds the inherent upper file size limit of the file management system; and if YES, capable of issuing a file dissecting enable message;
a file dissecting module, which is capable of responding to the file dissecting enable message from the file-size inspecting module by dissecting the electronic file into a number of small-size files, each of which is smaller in size than the inherent upper file size limit of the file management system, and all of which are linked according to their sequential order in data continuity into an interrelated chain; and
a file storing module, which is capable of firstly building a directory in the file management system in relation to the electronic file and then storing all the dissected small-size files generated by the file dissecting module into that directory.

8. The large-size electronic file storage and retrieval handling system of claim 7, wherein the computer platform is a desktop computer.

9. The large-size electronic file storage and retrieval handling system of claim 7, wherein the computer platform is a notebook computer.

10. The large-size electronic file storage and retrieval handling system of claim 7, wherein the computer platform is a network server.

11. The large-size electronic file storage and retrieval handling system of claim 7, wherein the file management system is a FAT (File Allocation Table) file management system of Microsoft Windows operating system.

12. The large-size electronic file storage and retrieval handling system of claim 7, further comprising:
a file retrieval module, which is capable of responding to a file-retrieval requesting event related to the electronic file by firstly searching through the file management system for a directory whose name is related to the name of the electronic file; and if found, capable of retrieving all the small-size files stored in that directory and combine the contents of these small-size files into a single data stream based on the sequential order of these small-size files.
